(19) United States
(12) Patent Application Publication
(10) Pub. No.: US 2010/0021372 A1
(43) Pub. Date: Jan. 28, 2010

(54) PROCESS FOR RECOVERY OF WATER ISOTOPOLOGUES FROM IMPURE WATER

(75) Inventors: Ian Richard Bonnett, Peterborough (CA); Anthony Busigin, Parkland, FL (US)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: GE HEALTHCARE UK LIMITED, Amersham (GB)

(21) Appl. No.: 12/521,028

(22) PCT Filed: Dec. 19, 2007
(86) PCT No.: PCT/GB07/04889

§ 371 Date: Jun. 24, 2009

Related U.S. Application Data
(60) Provisional application No. 60/884,025, filed on Jan. 9, 2007.

(51) Int. Cl. C01B 5/02

(52) U.S. Cl. 423/580.2

(57) ABSTRACT

Disclosed is a process and a system for recovery of isotopologues of water from an aqueous liquid stream containing dissolved impurities.

### BACKGROUND OF THE INVENTION

This invention relates generally to the recovery of isotopologues of water from impure water. More particularly, the invention relates to the recovery of tritium isotopologues of water from an aqueous liquid stream containing dissolved salts and acids or bases.

Tritium (symbol: T or ³H) is a radioactive isotope of hydrogen of atomic mass 3.016, having a β⁻ particle emission (0.019 MeV maximum) and a half life (T_{1/2}) of 12.3 years. It is both a product of, and is also used by the nuclear industry, the latter for example, in the production of tritium labelled organic molecules for use in radiotracer studies. As part of a tritium waste treatment process, there is often a requirement to remove tritium in the form of tritiated water from aqueous waste mixtures which contain dissolved salts as well as acids, bases or other dissolved organics. In order to adequately control the discharge of radioactivity in this stream, the detritiation process must be carried out in a highly efficient manner.

Conventionally, detritiation of water has involved separating water from such dissolved impurities using a water purification technology, followed by isotope separation using water (for example using water distillation), or by transfer of hydrogen species from water into the elemental hydrogen form, followed by isotope separation of the elemental hydrogen species. See, for example, Kalyanam, K. M. and Sood, S. K., “Fusion Technology”, Vol. 14, 1988, pp 524-528, which provides a comparison of the process characteristics of these types of systems. To achieve a high level of removal of tritium from the salt residues, it is necessary to boil the aqueous solution to dryness and wash and boil off the residues several times with fresh water. This may result in most of the acidic gases present in the initial waste mixture passing over with the tritiated water. In addition, a solid residue would remain which would have to be redissolved for disposal. Throughput would therefore be limited since the process could only be operated batch-wise. Further problems can occur in the detritiation of aqueous liquids containing dissolved impurities, since all hydrogen isotope separation technologies require pure water or pure elemental hydrogen isotopes as feed. If starting with water containing dissolved salts, acids, bases, or organics, the usual procedure is to first purify the water by removing impurities, resulting in production of a tritiated waste stream containing the impurities with unrecoverable tritium. This is a shortcoming of prior technology that is overcome by this invention.

### SUMMARY OF THE INVENTION

The present invention provides a simpler and more effective process to recover isotopically labelled water from aqueous solutions containing impurities such as dissolved salts, acids, bases and/or dissolved exchangeable organics. As disclosed herein, isotopologues are molecular entities that differ only in their isotopic composition (IUPAC Compendium of Chemical Technology, Electronic Version). As an example, water isotopologues may contain one or two deuterium or tritium atoms in place of hydrogen, or an ¹⁸O atom in place of ¹⁶O. The method herein described is applicable to the recovery of all isotopologues of water, for example, THO, T₂O, DHO, D₂O, as well as water containing ¹⁸O. The method is particularly useful for the recovery of tritium, by transferring tritium from an aqueous liquid stream into a substantially pure water vapour stream suitable for further processing, e.g. tritium isotope separation.

Thus, in a first aspect, there is provided a process for recovering water isotopologue(s) of interest from an aqueous liquid comprising dissolved impurities, the process comprising:
a) bringing said aqueous liquid into counter current contact with a gaseous stream comprising water vapour substantially depleted in said water isotopologue(s) of interest in an exchange column so as to provide an isotopic exchange of said water isotopologue(s) of interest from said aqueous liquid to said water vapour, thereby increasing the concentration of said water isotopologue(s) of interest in said water vapour; and
b) withdrawing from said exchange column water vapour enriched with said water isotopologue(s) of interest.

In a preferred embodiment, the water isotopologue(s) of interest comprise oxides of tritium. The preferred process therefore enables the recovery of tritium from an aqueous liquid comprising oxides of tritium and dissolved impurities such as dissolved salts, acids, bases and/or soluble organics. The process employs a stream of carrier gas saturated with clean (i.e. substantially tritium-free) water vapour in an exchange column to provide an isotopic exchange of tritium from the aqueous liquid to the water vapour. The process efficiently strips tritium from the aqueous stream in a continuous manner in a packed column with the liquid and vapour streams moving in a counter-current manner. The concentration of oxides of tritium in the water vapour phase is thereby increased, while dissolved solids and acid species etc. remain in the aqueous stream. Water vapour enriched with oxides of tritium is withdrawn from the exchange column. In an alternative embodiment, the water isotopologue(s) of interest comprise oxides of deuterium.

In the preferred embodiment, suitably, the process comprises introducing the aqueous liquid containing oxides of tritium (the liquid input stream) into an exchange column and allowing the mixture to flow in a first, preferably downward, direction through the exchange column and in counter-current contact with the gaseous/vapour stream containing tritium-free water vapour. Suitably, the lower tritium concentration water vapour is caused to flow in the opposite (upwards) direction to the aqueous liquid. Water vapour enriched with oxides of tritium is withdrawn from the top of the exchange column.

Suitably, the water exchange process takes place in a column packed with a packing material to facilitate mass transfer between the falling aqueous liquid and rising gaseous/water vapour. The packing material may be either a random dump, or alternatively structured packing and is employed to improve interfacial liquid to vapour contact and therefore to increase exchange efficiency between the vapour phase and the liquid phase. In principle, any suitable packing material may be used, providing that such material is inert under the conditions employed. Examples include glass beads, glass helices, ceramic packing, metal wire mesh packing, metal coils packing and perforated metal strips, and the like. Preferably the column is packed with glass helices, e.g. fenske glass helices.

The process may be operated at any suitable operating temperature, provided that the requirement for counter-current isotope exchange between liquid and vapour is satisfied. Typically, the process may be operated at a column temperature less than the boiling point of the aqueous liquid, preferably between about 85° C. and about 95° C., and more preferably at about 90° C. Preferably, the process is operated at a pressure of between 0.9 bar and 1.0 bar in order to minimise potential for leakage out.

Suitably, the molar water vapour flow up the column is greater than the downward molar flow of the aqueous liquid, thereby resulting in tritium transfer by isotopic exchange into the gaseous/vapour stream. In a preferred embodiment, the molar water vapour flow up the column is set at between 1.2 and 1.4 times the liquid flow down the column. The scale of the apparatus is suitable for the flows required. The upward gaseous/vapour flow is controlled by saturating a flow of a carrier, non-reacting gas, within a temperature-controlled evaporator, thereby allowing precise control of a partial pressure of water vapour. Such an arrangement provides multiple theoretical equilibrium stages between liquid and vapour states within the exchange column. The evaporator is heated by suitable heating means (not shown in FIG. 1) to a temperature approximately equal to that of the column temperature, i.e. between about 85° C. and 95° C. Tritium in the form of tritiated water, free of dissolved impurities is carried upwards and out of the column; detritiated liquid residues are removed from the bottom of the column.

Suitably, the carrier gas is selected such that it does not participate either in the isotopic exchange process, or in a chemical reaction with the components of the aqueous liquid. Examples of said carrier gas are helium, argon, nitrogen, dry air, or mixtures thereof. Preferably the gas is nitrogen.

The water vapour introduced at the bottom of the exchange column is substantially tritium-free relative to the liquid stream introduced at the top of the column.

### BRIEF DESCRIPTION OF THE FIGURE

FIG. 1 is a schematic diagram showing the component parts of a water detritiation system.

### DETAILED DESCRIPTION OF THE PREFERRED EMBODIMENTS

A detailed description of a preferred embodiment of the present invention is provided herein. It is to be understood however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

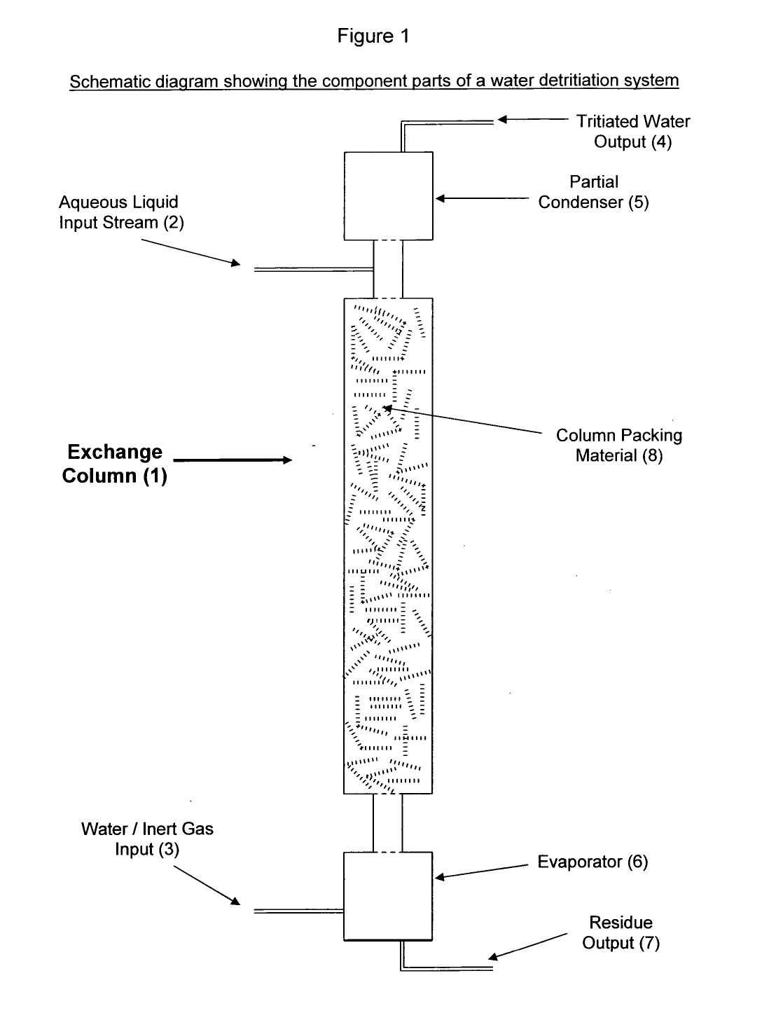

FIG. 1 shows a diagram of an exchange column (1) suitable for the recovery of tritium from an aqueous liquid comprising oxides of tritium and dissolved impurities. In accordance with the present invention, an aqueous liquid input stream (2) containing dissolved salts, acids, bases and/or soluble organics enters the top of the exchange column (1) and is allowed to flow in a downward direction through the column (1). A mixture (3) containing substantially tritium-free liquid water (3a) and carrier gas (3b) is fed to a column evaporator (6) located at the bottom of the column. In a preferred embodiment, the carrier gas consists of nitrogen. Heat is inputted to the evaporator to maintain the column temperature at between about 85° C. and about 95° C., preferably at about 90° C. The purpose of the carrier gas feed is to carry water vapour up the column. In the preferred embodiment, a nitrogen stream entering the evaporator is brought into intimate contact with the liquid water by a sparger (not shown) so as to produce fine bubbles.

The exchange column (1) may have a circular cross-section and is suitably between about 1 meter and about 10 meters in length (height) and between about 0.02 meters and about 2 meters in diameter. To facilitate access to the column, preferably each column is fitted with removable upper and lower end walls which carry connecting tubes to a partial condenser (5) and evaporator (6) respectively. The function of the partial condenser (5) is to condense a small portion of the water vapour to provide column reflux and to improve the efficiency of isotopic exchange. The partial condenser temperature may also be controlled to carry forward the correct amount of isotopically enriched water for downstream processing. Preferably, the column (1) has dimensions of between 1 and 2 meters in height. Suitably, the exchange column (1) may be formed from a rigid material that is resistant to aqueous-based fluids and elevated temperatures. Preferably the column is constructed from stainless steel.

Suitably, the exchange column (1) is filled with a packing material (8) so as to provide abundant surface area for mass transfer between the falling aqueous liquid and rising gas/vapour inside the column. Suitably, the packing material is either a highly wettable random dump packing or alternatively may be a structured packing. Within the column, isotope exchange occurs between the rising water vapour and the falling aqueous liquid stream. The gas/vapour and liquid flows in the column are counter-current, with the molar flow of vapour suitably larger than the molar flow of liquid, resulting in tritium transfer by isotopic exchange into the gaseous/vapour stream. Preferably, the molar water vapour flow up the column is set at between 1.2 and 1.4 times the liquid flow down the column.

The upward gaseous/vapour flow is controlled by saturating the flow of carrier, non-reacting gas within the temperature controlled evaporator (6), allowing precise control of a partial pressure of water vapour and thereby providing multiple theoretical equilibrium stages between liquid and vapour states within the column. The column may therefore have any number of theoretical equilibrium stages, given sufficient column height. The upward flow of vapour is set precisely by controlling the temperature of the evaporator (6) and the bottom feed of tritium free water (3a) and carrier gas flow (3b). The partial pressure of the vapour in the column is controlled simply by saturating the gas stream (3b) entering the evaporator (6). Tritium in the form of tritiated water, free of dissolved impurities is carried upwards and out of the exchange column; detritiated liquid residues are removed from the bottom of the column.

In one example according to the process, tritiated water is stripped from a hydrochloric acid/HTO stream. Thus, a humidified nitrogen stream is allowed to flow up the column and is caused to come into counter-current contact with an input stream of hydrochloric acid/HTO. Hydrochloric acid is strongly ionised in aqueous solution, freely exchanging hydrogen isotopes with liquid water. The tritium-containing water/hydrochloric acid input stream therefore undergoes isotopic exchange with tritium free water vapour according to the following isotope exchange reactions:

HTO_{(liq)}+H₂O₍ᵥₐₚ₎⇄H₂O_{(liq)}+HTO₍ᵥₐₚ₎ (i)

and

TCl_{(liq)}+H₂O₍ᵥₐₚ₎⇄HCl_{(liq)}+HTO₍ᵥₐₚ₎ (ii)

At the bottom of the exchange column (1), a substantially detritiated aqueous liquid stream containing dissolved salts, acids, bases and/or soluble organics is allowed to exit the column as a residue output (7) on suitable level control in the sump of the column. For the purposes of isotope exchange, the rate of outflow to drain is suitably less than the tritium-free liquid water feed rate to the evaporator. The tritium concentration of the liquid effluent is low enough for discharge to the environment or to meet the requirements or a specific application. According to the process described, a liquid detritiation factor (liquid tritium in/liquid tritium out) of at least 5000 may be obtained with suitable column height. The column height and water vapour to liquid flow ratio may be adjusted to produce any desired liquid detritiation factor, from 1 to 10,000 or even greater. Pure or substantially pure tritiated water vapour exits with the carrier gas from the top of the column (4) and is allowed to condense. The column may have any number of theoretical equilibrium stages, given sufficient column height. The process is simple and reliable, having no net chemical reactions, operating at less than boiling temperature, and typically near atmospheric pressure.

In another aspect, the present invention provides a system for recovering water isotopologue(s) of interest from an aqueous liquid comprising dissolved impurities. The system comprises an exchange column for bringing said aqueous liquid into counter current contact with a gaseous stream comprising water vapour substantially depleted in said water isotopologue(s) of interest so as to provide an isotopic exchange of said water isotopologue(s) of interest from said aqueous liquid to said water vapour, thereby increasing the concentration of said water isotopologue(s) of interest in said water vapour.

In a particular embodiment, the water isotopologue(s) of interest comprise oxides of tritium. In another embodiment, the water isotopologue(s) of interest comprise oxides of deuterium.

While FIG. 1 shows only one liquid detritiation column (1) employed in the process of the present invention, it is to be understood that in practice, two or more columns may be employed in parallel so as to optimise separation of tritiated water from an impure feedstock. Alternatively two or more columns may be employed in series to increase the recovery of tritium. Likewise, the process according to the present invention may be operated batchwise, or alternatively in a continuous process. Preferably, the process is a continuous process. Furthermore, the process is compatible with any downstream conversion process to convert tritiated water into elemental hydrogen by such means as electrolysis, water decomposition by water gas shift reactor (i.e. palladium membrane reactor) or a hot metal bed reactor.

The drawing constitutes a part of this specification and includes an exemplary embodiment to the invention, which may be embodied in various forms. It is to be understood that in some instances various aspects of the invention may be shown exaggerated or enlarged to facilitate an understanding of the invention.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A process for recovering water isotopologue(s) of interest from an aqueous liquid comprising dissolved impurities, the process comprising:
a) bringing said aqueous liquid into counter current contact with a gaseous stream comprising water vapour substantially depleted in said water isotopologue(s) of interest in an exchange column so as to provide an isotopic exchange of said water isotopologue(s) of interest from said aqueous liquid to said water vapour, thereby increasing the concentration of said water isotopologue(s) of interest in said water vapour; and
b) withdrawing from said exchange column water vapour enriched with said water isotopologue(s) of interest.

2. The process of claim 1, wherein said water isotopologue(s) of interest comprise oxides of tritium.

3. The process of claim 1, wherein said water isotopologue(s) of interest comprise oxides of deuterium.

4. The process of claim 1, wherein the stream of water vapour introduced to the column is admixed with a carrier gas.

5. The process of claim 4, wherein said carrier gas is selected from helium, argon, nitrogen, dry air, or mixtures thereof.

6. The process of claim 5, wherein said carrier gas is nitrogen.

7. The process of claim 1, wherein said exchange column is packed with a packing material employed to improve interfacial liquid to vapour contact.

8. The process of claim 7, wherein said packing material is selected from glass beads, glass helices, ceramic packing, metal wire mesh packing, metal coils packing and perforated metal strips.

9. The process of claim 8, wherein said packing material comprises glass helices.

10. The process of claim 1, wherein said process is a continuous process.

11. The process of claim 1, wherein said process operates at a temperature between about 85° C. and 95° C.

12. The process of claim 1, wherein said exchange column is operated at a pressure of between 0.9 and 1.0 bar.

13. A system for recovering water isotopologue(s) of interest from an aqueous liquid comprising dissolved impurities the system comprising an exchange column for bringing said aqueous liquid into counter current contact with a gaseous stream saturated with water vapour substantially depleted in said water isotopologue(s) so as to provide an isotopic exchange of the said water isotopologue(s) from said aqueous liquid to said water vapour.

14. The system of claim 13, wherein said water isotopologue(s) comprise oxides of tritium.

15. The system of claim 13, wherein said water isotopologue(s) comprise oxides of deuterium.
